(19) United States
(12) Patent Application Publication
(10) Pub. No.: US 2016/0103608 A1
(43) Pub. Date: Apr. 14, 2016

(54) VIRTUAL KEYBOARD OF A COMPUTING DEVICE TO CREATE A RICH OUTPUT AND ASSOCIATED METHODS

(71) Applicant: Vellum Tech Corporation, Cupertino, CA (US)

(72) Inventors: Chandra Nukala, Fremont, CA (US); Surya Panditi, Cupertino, CA (US); Ishwar Joshi, Cupertino, CA (US)

(21) Appl. No.: 14/685,141

(22) Filed: Apr. 13, 2015

Related U.S. Application Data
(60) Provisional application No. 62/061,696, filed on Oct. 9, 2014.

(51) Int. Cl. G06F 3/0488; G06F 3/023; G06K 9/22; G06T 7/40; G06F 3/042; G06F 3/041; G06T 13/80

(52) U.S. Cl. CPC G06F 3/04886; G06F 3/0416; G06F 3/0233; G06T 13/80; G06T 7/408; G06F 3/0426; G06K 9/224; G06T 2200/04; G06F 2203/04803; G06T 2213/08

(57) ABSTRACT

A method, a device and/or a system of a virtual keyboard of a mobile device to generate a rich output and associated methods. A method and/or system of a computing device to determine that an alpha-numeric character is placed into a memory of the computing device responsive to an entry of the alpha-numeric character by a user of the computing device through a virtual keyboard, to select at least one of a stylized font to the alpha-numeric character, a color to the alpha-numeric character, a foreground, a background, a graphics and an animation to the alpha-numeric character, to apply at least one of the selected stylized font, the color, the foreground, the background, the graphics and the animation using a rich-typeface filter to the alpha-numeric character, to generate a rich output based on an application of the rich-typeface filter to the alpha-numeric character and to place the rich output into the memory to be used by one or more applications of the computing device.

### CLAIM OF PRIORITY

This application is a non-provisional application and claims priority, and incorporates by reference the entirety of the disclosure of the U.S. Provisional Application No. 62/061,696 titled “VIRTUAL KEYBOARD OF A MOBILE DEVICE TO CREATE GIF FILES AND ASSOCIATED METHODS” filed on Oct. 9, 2014.

### FIELD OF THE TECHNOLOGY

This disclosure relates generally to the field of computer input device, and more particularly, to a system, method, and apparatus of a virtual keyboard to generate rich output.

### BACKGROUND

Keyboard is a standard input device for a computer. Computer devices are available in different shapes and sizes and include various a smartphone a tablet computing device, a laptop computer, a dedicated server, a desktop computer, a gaming console, or other applicable digital device. Many of these computer devices include touchscreens that has a touchscreen keyboard. The current types of keyboard keys are limited to alphanumerical characters and do not include mechanisms of customizing keyboard keys or using a variety of fonts or graphics.

### SUMMARY

A method, a device and/or a system of a virtual keyboard of a mobile device to generate a rich output and associated methods.

A method and/or system of a computing device to determine that an alpha-numeric character is placed into a memory of the computing device responsive to an entry of the alpha-numeric character by a user of the computing device through a virtual keyboard, to select at least one of a stylized font to the alpha-numeric character, a color to the alpha-numeric character, a foreground, a background, a graphics and an animation to the alpha-numeric character, to apply at least one of the selected stylized font, the color, the foreground, the background, the graphics and the animation using a rich-typeface filter to the alpha-numeric character, to generate a rich output based on an application of the rich-typeface filter to the alpha-numeric character and to place the rich output into the memory to be used by one or more applications of the computing device.

The method and/or system of computing device to determine a context in which the virtual keyboard is activated, wherein the context is based on a function being performed through the computing device by the user through an application using a content accessed by the user of the computing device; determine whether the content is a video file, an audio-visual file, a graphics-interchange-format (GIF) file based on the context; select based on the context which of the following operations are performed when the rich output is created, wherein the operations include at least one of: to copy the rich output to a clipboard of the operating system, to store in a photo library, to communicate the rich output through an application of the computing device, to communicate to a third-party website server through an application programming interface offered by the third-party website server through an application of a mobile device.

The method and/or system of computing device to customize and/or configure a virtual keyboard. The method and/or system of computing device to create, store and edit virtual keyboard profiles.

The method and/or system of a computing device wherein the available stylized fonts, colors, foregrounds, backgrounds, graphics and animations for selection are customized by the user.

The method and/or system of a computing device, further comprising: communicating the rich output to a recipient device through at least one of an application of the computing device and an operating system of the computing device. The method and/or system of a computing device wherein the recipient device uses at least one of a messaging application, and a standard electronic mail website to access the rich output.

The method and/or system of a computing device, further comprising: to determine a context in which the virtual keyboard is activated, wherein the context is based on a function being performed through the computing device by the user through an application using a content accessed by the user of the computing device; to determine whether the content is a video file, an audio-visual file, a graphics-interchange-format (GIF) file based on the context; to select based on the context which of the following operations are performed when the rich output is created, wherein the operations include at least one of: to copy the rich output to a clipboard of the operating system, to store in a photo library, to communicate the rich output through an application of the computing device, to communicate to a third-party website server through an application programming interface offered by the third-party website server through an application of a mobile device.

The method and/or system of a computing device further comprising at least one of: wherein the rich output includes content that is at least one of a lossless compression output, a Graphics Interchange Format (GIF) output and a streaming video output; wherein the portions or whole of the generated rich output are included in an application message sent to a recipient device; wherein the application message comprises at least one of: an in-line Hypertext Markup Language (HTML) script, non-looping rich output and non-looping content.

The method and/or system of a computing device wherein the selecting is based on at least one of: selection of a user; default configuration setting; selected virtual keyboard profile. The method and/or system of a computing device further comprising: to configure or customize the virtual keyboard keys; to save one or more virtual keyboard profiles; to activate one or more virtual keyboard profiles; to use one or more virtual keyboard profiles.

The method and/or system of a computing device further comprising at least one of: to select a default setting of one or more font, styles, foreground, background, graphics and animation settings; to customize one or more buttons on the menu or task bar of the virtual keyboard by adding, editing or removing buttons; to prioritize the buttons on the menu or task bar of the virtual keyboard.

The method and/or system of a computing device further comprising: to use a set of alpha-numeric characters responsive to an entry by the user; wherein the set of alpha-numeric characters is selected based on at least one of: selection from an existing file, clipboard and keyboard.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a view of a computing device wherein an rich-typeface filter is applied to an alpha-numeric character entered by a user of the computing device through a virtual keyboard and a rich output is generated. The rich output generated can be used by an application on the computing device. The rich output is sent to a recipient device through a network, according to one embodiment.

FIG. 2 is a view of the computing device of FIG. 1 illustrating communication of the rich output to another device through an application programming interface, according to one embodiment.

FIG. 3 is a view of a configuration application of the virtual keyboard, according to one embodiment.

FIG. 4 is a view of a configuration application of the virtual keyboard, according to one embodiment.

FIG. 5 is an exploded view of the configuration function illustrating different subroutines, according to one embodiment.

FIG. 6 is an exploded view of the customization function illustrating different subroutines, according to one embodiment.

FIG. 7 is an exploded view of an application process of the rich output of computing device of FIG. 1 to a recipient device, according to one embodiment.

FIG. 8A is a flow based on operations of the computing device of FIG. 1 while using a virtual keyboard, according to one embodiment.

FIG. 8B is a flow based on operations of the computing device of FIG. 1 while using a virtual keyboard, according to one embodiment.

FIG. 9 is a process flow diagram of the computing device of FIG. 1, according to one embodiment.

FIG. 10A is a conceptual view illustrating the user experience of creation of the rich output using the virtual keyboard of the computing device of FIG. 1, according to one embodiment.

FIG. 10B is a conceptual view illustrating the continuation of conceptual view of FIG. 10A, according to one embodiment.

FIG. 10C is a conceptual view illustrating the user experience of the receiver of message sent from the computing device of FIG. 10A, according to one embodiment.

FIG. 11 is a schematic diagram of exemplary computing devices that can be used to implement the methods and systems disclosed herein, according to one embodiment

Other features of the present embodiments will be apparent from the accompanying drawings and from the detailed description that follows.

### DETAILED DESCRIPTION OF THE DRAWINGS

The virtual keyboard includes mechanics to create rich and/or plaintext and/or graphics using a variety of typefaces, font weights and styles, foreground and backgrounds that creates rich output. Optionally, the virtual keyboard creates rich output that includes graphics. The rich output may also include animations.

The virtual keyboard is a flexible keyboard that a user can customize for his/her particular needs. A user may add or delete custom keys with shortcuts and tabs that he/she uses frequently. If a user prefers to use a particular typeface with a selected font, weight, style, foreground and background, the user can make that selection his selection for the virtual keyboard.

The virtual keyboard can be turned on or off based on the user need at a given time. If the user wants to turn off the virtual keyboard and go back to using the classical keyboard, he/she may do so at any time.

By enabling the use of variety of typefaces, font weights and styles, backgrounds and/or foregrounds, the virtual keyboard allows for creative and emotional expressions for a user. Such an expression is not limited or tied to a particular application and is available to the user at the operating system level. For example, the current font/graphics applications or toolbars that are available in applications such as Word document or Paint cannot be seamlessly used at the keyboard level for all different applications. The virtual keyboard provides this flexibility at the operating system level thereby freeing the keyboard styles from different applications and giving the ownership of the keyboard style to the user.

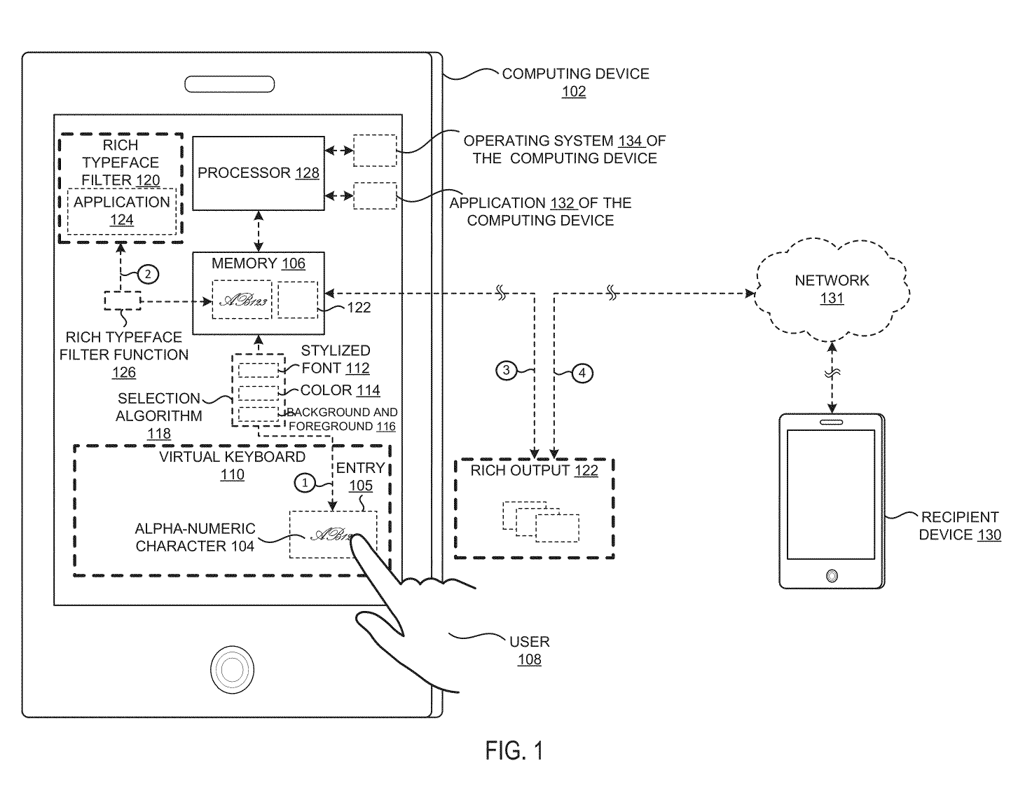

In one embodiment, FIG. 1 depicts a method that includes a computing device 102 to determine that an alpha-numeric character 104 is placed into a memory 106 of the computing device 102 responsive to an entry 105 of the alpha-numeric character 104 by a user 108 of the computing device 102 through a virtual keyboard 110. The method applies a stylized font 112 to the alpha-numeric character 104, a color 114 to the alpha-numeric character 104, and a background and foreground 116 to the alpha-numeric character 104 based on a selection or configuration setting using selection algorithm 118. The method applies an rich-typeface filter 120 (e.g., using the rich-typeface filter function 126 of the computing device 102) to the alpha-numeric character 104. The method generates an rich output 122 based on an application 124 of the rich-typeface filter 120 to the alpha-numeric character 104.

The rich output 122 visually represents the alpha-numeric character 104 placed into motion based on the rich-typeface filter 120 (e.g., using the rich-typeface filter function 126 of the computing device 102). The alpha-numeric character 104 includes all keyboard inputs available on the computing device 102 including any uppercase/lowercase alphabets, numbers and special characters. The alpha-numeric character 104 includes one or more keyboard inputs received from the user 108 at entry 105. The entry 105 interfaces with the regular keyboard input of the computing device 102 to get input of different keyboard characters from the user 108.

The rich output 122 visually represents application of the stylized font 112 to the alpha-numeric character 104, the color 114 to the alpha-numeric character 104, and the background and foreground 116 to the alpha-numeric character 104 based on the selection or configuration setting using selection algorithm 118 of the user 108 using a processor 128 and the memory 106 of the computing device 102. The method places the rich output 122 into the memory 106. In one embodiment, the rich output 122 is communicated to a recipient device 130 through an application 132 of the computing device 102 and/or an operating system 134 of the computing device 102 by transmitting through a network 131.

The computing device 102 (e.g., mobile phones, tablet) may be any wireless electronic device capable of transmitting an analog or digital signal for contacting and/or allows for two-way communication. The alpha-numeric character 104 may be a combination of alphabetic and numeric characters (e.g., a collection of Latin letters and Arabic digits) or a text constructed from this collection using the computing device 102. The entry 105 may be the process of writing the alpha-numeric character 104 using the computing device 102, according to one embodiment.

The memory 106 may be the electronic holding place for programs, instructions and/or data on a permanent and/or temporary basis that the microprocessor of the computing device 102 can reach quickly. The user 108 may be the person operating the computing device 102. The virtual keyboard 110 may be a software component that allows a user 108 to enter the alpha-numeric character 104. A virtual keyboard 110 may usually be operated with multiple input devices, which may include a touchscreen, an actual computer keyboard and/or a computer mouse. The stylized font 112 may be a set of printable or displayable alpha-numeric character 104 in a specific style and/or size that is depicted in a mannered and/or a non-realistic style. The color 114 may be the hue and/or shade of the alpha-numeric character 104 selected using the computing device 102 by the user 108. The background 116 may be the part of a design that forms a setting for the alpha-numeric character 104 that appears furthest from the viewer of the computing device 102, according to one embodiment.

The alpha-numeric character 104 may be placed into a memory 106 of the computing device 102 entered by the user 108 though the virtual keyboard 110. In circle ‘1’, the user 108 may select the stylized font 112, the color 114, and the background 116 to the alpha-numeric character 104 by applying the selection algorithm 18. In circle ‘2’, the rich-typeface filter 120 may be applied to the alpha-numeric character 104 to generate rich output 122. In circle ‘3’, the generated rich output 122 may be placed into the memory. In circle ‘4’, the generated rich output 122 may be communicated to the recipient device 130 through the network 131, according to one embodiment.

In one embodiment, the selection algorithm 118 may be a process or set of rules to be followed while the user 108 chooses the alpha-numeric character 104 using the computing device 102. In another embodiment, the selection algorithm 118 allows the user 108 to dynamically change the styles of the alpha-numeric character 104 while entering the characters using a keyboard. The rich-typeface filter 120 may be a program and/or section of code that is designed to examine each arbitrary input motion signal (e.g., graphical signal) and modulates it for certain qualifying criteria in such way that the output motion is more alive and/or animated. The rich output 122 may be the collection of data and/or information created after application of rich-typeface filter 120 to the alpha-numeric character 104 entered by the user 108 using the computing device 102. The application 124 may be a program and/or a group of programs designed for the user 108 of the computing device 102 to create rich output 122 using the virtual keyboard 110. The rich-typeface filter function 126 may be a named section of a program that performs a specific task of modulating the alpha-numeric character 104 entered by the user 108 using the computing device 102, according to one embodiment.

The processor 128 may be a central processing unit (CPU) within the computing device 102 that carries out the instructions of a computer program by performing the basic arithmetical, logical, and input/output operations of modulating the alpha-numeric character 104 entered by the user 108 using the computing device 102. The recipient device 130 may be the wireless electronic device receiving the rich output 122 from the user 108 of the computing device 102. The network 131 may be a group of two or more computer systems (e.g., a smartphone, mobile, tablet) interconnected by communication paths. The application of the computing device 132 may be a program and/or a group of programs designed for the user 108 of the computing device 102 to communicate rich output 122 to the recipient device 130 using the virtual keyboard 110. The operating system of the computing device 134 may be the low-level software that supports the basic functions (e.g., scheduling tasks, controlling peripherals) of the computing device 102, according to one embodiment.

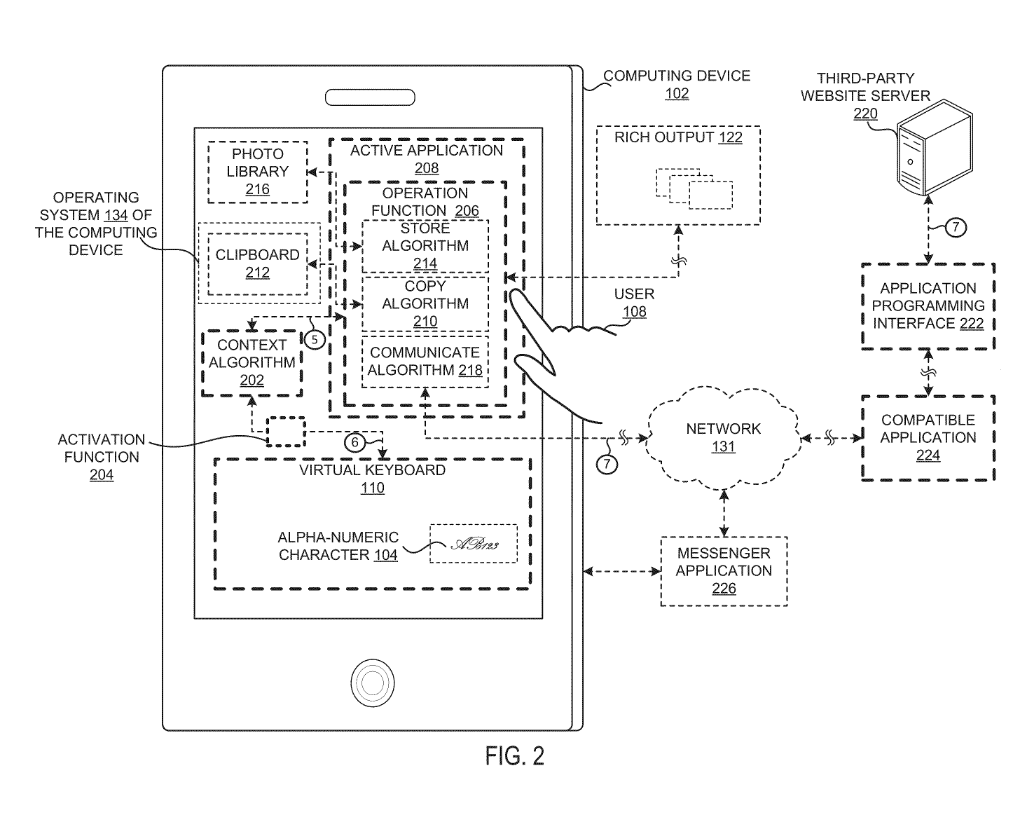

In one embodiment, FIG. 2 depicts a method that determines a context (e.g., using the context algorithm 202 of the computing device 102) in which the virtual keyboard 110 is activated using the activation function 204. The context (e.g., using the context algorithm 202 of the computing device 102) may be based on a function (e.g., using the operation function 206 of the computing device 102) being performed through the computing device 102 by the user 108 through an active application 208 currently being accessed by the user 108 of the computing device 102. The method may automatically select based on the context (e.g., using the context algorithm 202 of the computing device 102) which of the following operations (e.g., using the operation function 206 of the computing device 102) are performed when the rich output 122 is created. The operations may include copying (e.g., using the copy algorithm 210 of the computing device 102) the rich output 122 to a clipboard 212 of an operating system, storing (e.g., using the store algorithm 214 of the computing device 102) in a photo library 216, communicating (e.g., using the communicate algorithm 218 of the computing device 102) directly to a third-party website server 220 through an application programming interface 222 offered by the third-party website server 220 through a compatible application 224 of the mobile device that may be communicatively coupled with the third-party website server 220 through the application programming interface 222, and/or communicating the rich output 122 through a messenger application 226 of the computing device 102.

The context algorithm 202 may be the process or set of rules to be followed for identifying the conditions or factors to determine the activation of virtual keyboard 110 of the computing device 102. The activation function 204 may be a named section of a program that performs a specific task of actuating the virtual keyboard 110 of the computing device 102. The operation function 206 may be a named section of a program that performs a specific task of identifying the action of the user 108 of the computing device 102. The active application 208 may be a program and/or a group of programs designed and/or accessed by the user 108 of the computing device 102 to enable the user 108 to perform a function through the virtual keyboard 110, according to one embodiment.

The copy algorithm 210 may be a process or set of rules to be followed for reproducing the rich output 122. The clipboard 212 may be a temporary storage area where the rich output 122 generated after application of rich-typeface filter 120 is kept for pasting into the operating system of the computing device 134. The store algorithm 214 may be a process or set of rules to be followed for retaining the rich output 122. The photo library 216 may be a collection of precompiled routines that a program can use to store the rich output 122 generated after application of rich-typeface filter 120. The communicate algorithm 218 may be a process or set of rules to be followed for sharing and/or exchanging the rich output 122 with the recipient device 130 through the network 131, according to one embodiment.

The third-party website server 220 may be a computer or computer program which manages access to a centralized resource or service in the network 131 of a set of related web pages typically served from a single web domain to a person or group besides the two primarily involved in communication of the rich output 122. The application programming interface 222 may be a set of routines, protocols, and/or tools for building software applications for communication of the rich output 122. The compatible application 224 may be a program and/or a group of programs designed to run on another device (e.g., recipient device 130) without any change in the rich output 122 generated by the computing device 102. The messenger application 226 may be a program and/or a group of programs designed to send and/or receive rich output 122, according to one embodiment.

FIG. 2 illustrates the computing device 102 may enable the user 108 to access the active application 208 and perform various functions. The virtual keyboard 110 may be activated based on these functions using the context algorithm 202. The computing device 102 may be communicatively coupled to the third-party website server 220 through a network 131. The third-party website server 220 may be communicatively coupled to the compatible application 224. The third-party website server 220 may offer the application programming interface 222 through the compatible application 224, according to one embodiment.

FIG. 2 illustrates the active application 208 accessed by the user 108 enables user to perform different functions (e.g., store, copy, and/or communicate). In circle ‘5’, the context algorithm 202 determines the functions performed by the user 108. In circle ‘6’, the activation function 204 enables activation of virtual keyboard 110 based on determination of context of the functions performed by the user 108. In circle ‘7’, the rich output may be communicated to the third-party website server 220, according to one embodiment.

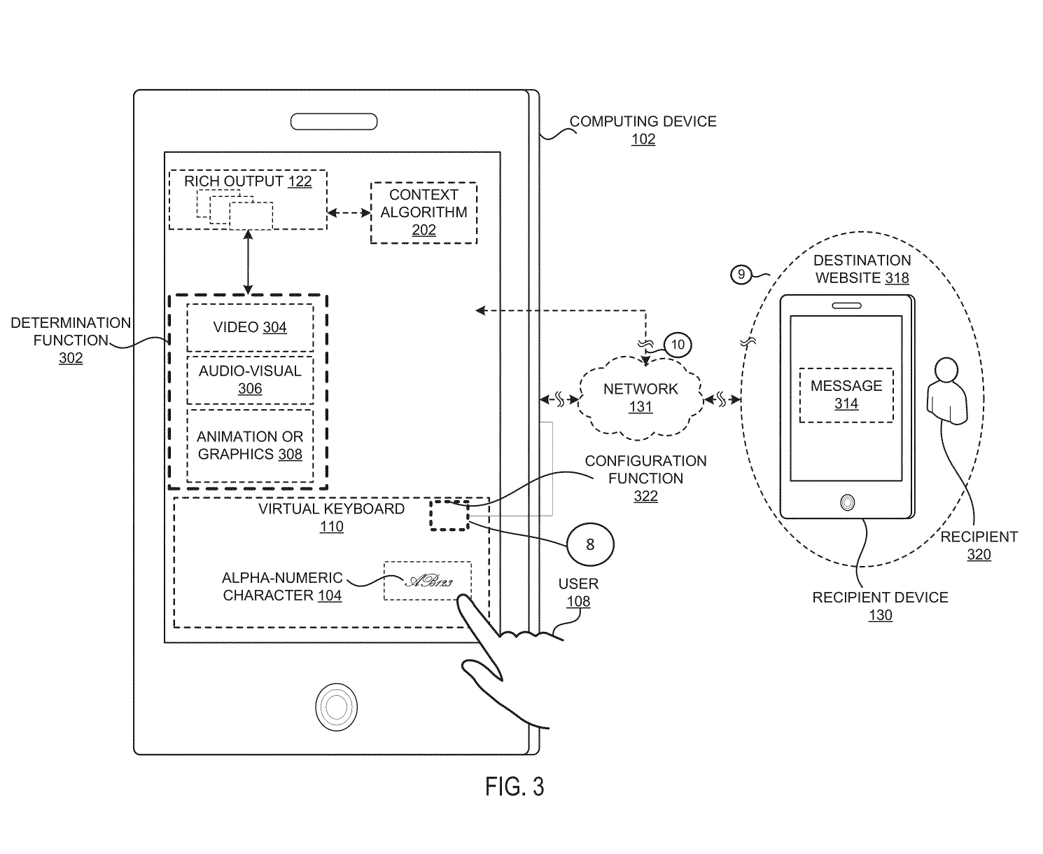

In one embodiment, FIG. 3 depicts a method that may determine (e.g., using the determination function 302 of the computing device 102) whether the rich output 122 is a video file 304, an audio-visual file 306, and/or a graphics-interchange-format (GIF) file 308 based on the context (e.g., using the context algorithm 202 of the computing device 102). The context algorithm 202 and the determination function 302 apply the proper content context based on the current application in use by the user. The determination function 302 interfaces with the current content that includes all types of contents generated on the computing device 102. For example, the content includes documents, files and multimedia files including audio, video and images. An active application determines the current active content type that interfaces with the virtual keyboard 110 to generate rich output 122. In one embodiment, the determination function 302 and/or the context algorithm 202 interface using application programming interface different applications on the computing device 102.

Particularly, FIG. 3 builds on FIG. 1 and FIG. 2 and further adds a determination function 302, a video file 304, an audio-visual file 306, a graphics-interchange format (GIF) file 308, a message 314, a destination website 318, a recipient 320, and a configuration function 322, according to one embodiment.

The determination function 302 may be a named section of a program that performs a specific task of establishing the category of the rich output 122. The video file 304 may be a digitized rich output 122 generated by the computing device 102 in a moving visual and audio media. The audio-visual file 306 may be an rich output 122 generated by the computing device 102 using both sight and sound, typically in the form of images and recorded speech and/or music. The graphics-interchange format (GIF) file 308 may be an rich output 122 generated by the computing device 102 that contains a set of images within the single file having their RGB values defined in a palette table (e.g., that can hold up to 256 entries), and the data for the image may refer to the colors by their indices (e.g., 0-255) in the palette table that are presented in a specified order, according to one embodiment.

The message 314 may be the rich output 122 received by the recipient in various formats (e.g., video file 304, audio-visual file 306 and/or graphics-interchange format (GIF) file 308), according to one embodiment.

The destination website 318 may be a set of related web pages typically served from a single web domain to which the rich output 122 is sent. The recipient 320 may be the user of the destination website 318 receiving the rich output 122 sent by the user 108. The configuration function 322 may be a named section of a program that performs a specific task of setting up the business rule for the recipient 320 of the rich output 122, according to one embodiment.

FIG. 3 illustrates the category of the rich output 122 may be established using the determination function 302 based on the context (e.g., using context algorithm 202). The recipient 320 may be the user communicatively coupled with the destination website 318. The destination website 318 may be communicatively coupled to the computing device 102 through a network 131.

FIG. 3 illustrates establishing the category of the rich output 122 by application of determination function 302. In circle ‘8’, user 108 of the computing device 102 may configure (e.g., using the configuration function 322) the virtual keyboard settings. In circle ‘10’, the message generated includes portions of rich output 122 and is transmitted through the network 131 to another recipient device 130 used by the recipient 320.

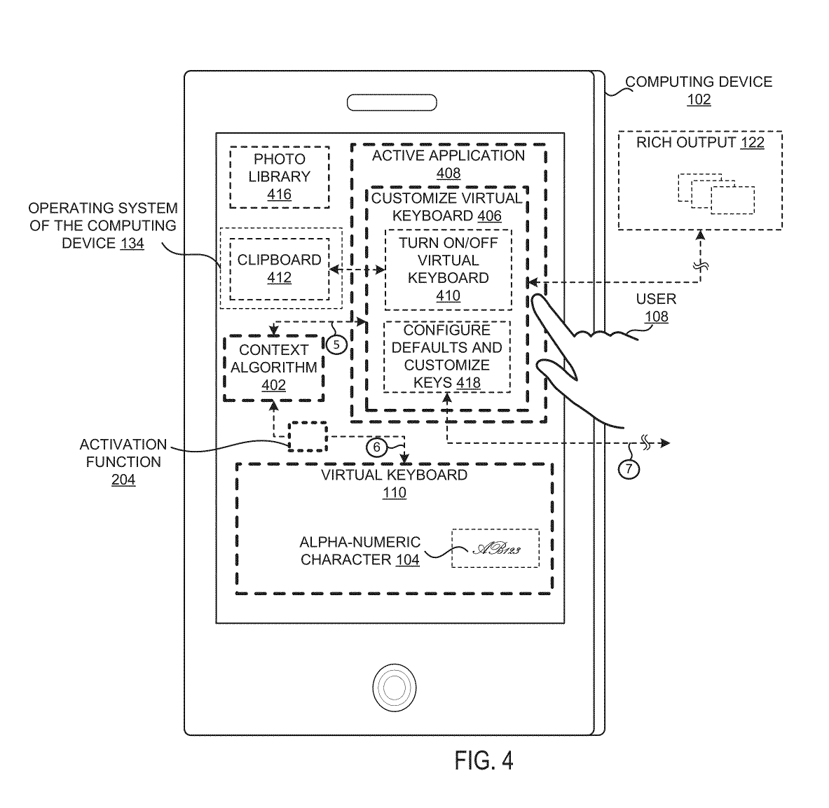

FIG. 4 is an application view of user of a computing device 102, according to one embodiment. Particularly, FIG. 4 describes an active application 408 that includes a customize virtual keyboard routine 406, turn on or off virtual keyboard routine 410, and a configuration routine for default settings and customizing the keys in the virtual keyboard routine 418.

The context algorithm 402 may be a context sensitive application which enables the rich output 122 to be executed in context of the selection content, i.e. media or alpha-numeric text. The process of the running (e.g., carry out, accomplishing) the rich output 122 using the context algorithm 402 with the clipboard 412 and/or photo library 416. The active application 408 may be the current application that is active on the operating system and that automatically executes the rich output 122. The active application 408 can change with different actions from the user 108 as he/she proceeds to perform different computing tasks on the computing device 102. In one embodiment, it is understood that the virtual keyboard works seamlessly across different applications on the computing device 102. The user 108 can create content including rich output using a wide variety of applications available today.

The turn on or off function 410 allows the user to turn off the virtual keyboard when the user is not interested in generating rich output 122. When a user wants simple or regular text, he/she can switch back to the regular or normal mode of the keyboard. The turn on or off function 410 has a user interface to get user 108 feedback on the setting. Similarly, the user 108 can turn on the virtual keyboard setting back when he/she wants to continue using the virtual keyboard. In one embodiment, the user can automate the process of turning the virtual keyboard on/off using a variety of different methods including interfacing using application programming interface from another application on the same computing device 102, peer to peer communication and/or remote server/client communication from another device.

The configuration and customization routine 418 allows the user to customize the virtual keyboard 110. The virtual keyboard includes different keys for enriching the alpha-numeric character 104 including different color palettes, styles, foregrounds and background keys and tabs. A user may set a preferred virtual keyboard profile that works best for him/her. For example, if a user is working on an animation film, the user may set a particular font style for the dialogues of the characters. The user may also select different background and foreground styles. If the user stops working on an animation film and is texting his friends, he may use a virtual keyboard that has frequently used icons and images. When using an email or document for business or work, the user may activate a different virtual keyboard profile.

In one embodiment, different virtual keyboard profiles may actively interface with different applications on the computing device 102. In one embodiment, a user may create and enable different virtual keyboard profiles and publish them for use on the computing device 102. In one embodiment, the user may publish different virtual keyboard profiles that can be saved and transferred to other computing devices or shared between different users of different recipient devices.

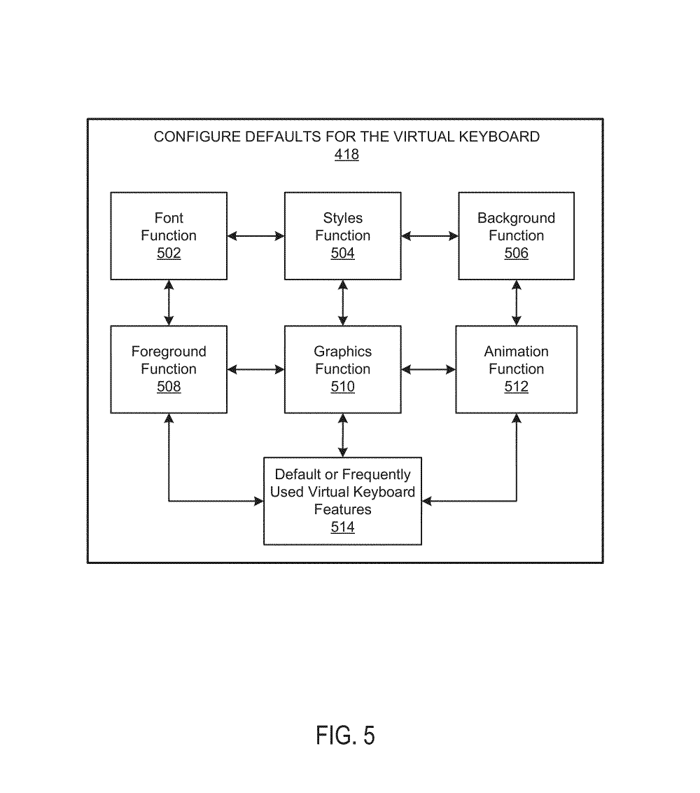

FIG. 5 is an exploded view of 418 configuring default settings for the virtual keyboard 110. Particularly, FIG. 5 illustrates different tabs and menus including configuring different virtual keyboard profiles and features using font function 502, styles function 504, background function 506, foreground function 508, graphics function 510 and animation function 512. The default or frequently used virtual keyboard features 514 can be saved and stored as different virtual keyboard profiles that may be activated by different application on the computing device 102.

The font function 502 allows for the user 108 to select default font settings. The styles function 504 allows for the user 108 to select default styles settings. The background function 506 allows for the user 108 to select default background settings. The foreground function 508 allows for the user 108 to select default foreground settings. The graphics function 510 allows for the user 108 to select default graphics settings. A user may upload his/her own customized graphics files that may be invoked through the virtual keyboard 110. The animation function 512 allows for the user 108 to select default animation settings. Similar to graphics, a user may upload his/her own customized animation files that may be subsequently invoked through the virtual keyboard 110. Similarly, the user may upload his customized font files, styles files, background files and foreground files that may be subsequently invoked through the virtual keyboard 110. It is understood, that the virtual keyboard 110 is customizable using different user interfaces including graphical interface and/or simple command line interface in combination with or without any sound or microphone input features on a device. A simple command line interface may be useful to network administrators to set up the virtual keyboard profile settings for different computing devices on their network to ensure that everyone uses the same rich output settings. A graphical user interface may allow for easy use for users that are not used to using computing devices. For example, the graphical user interface may be combined with sound features to provide accessibility functions for people with disabilities to help ease the rich output generation.

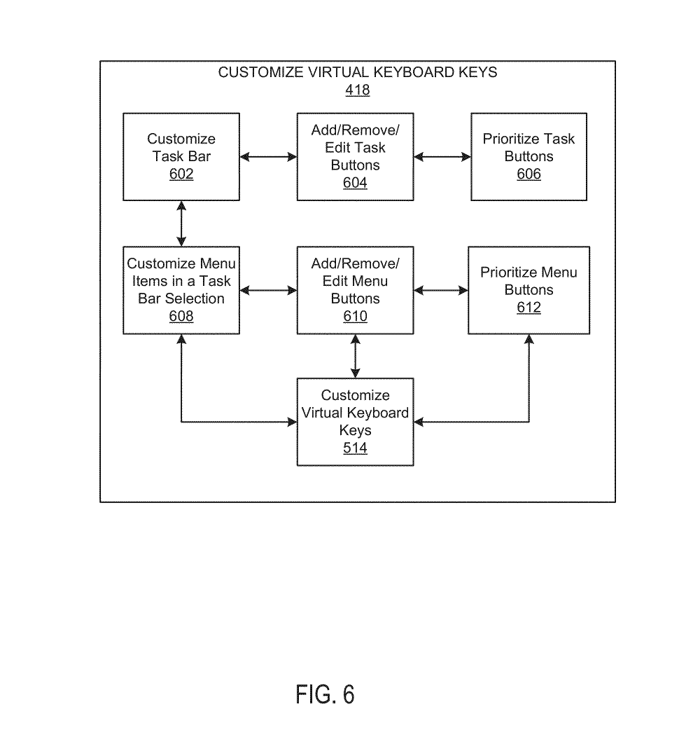

In one embodiment, FIG. 6 shows the exploded view of the customization of the virtual keyboard keys 418 of FIG. 4. Particularly, FIG. 6, describes different taskbars and menu functions that can be set by a user of the virtual keyboard 110. The customize task bar 602 function allows a user to add, edit or remove task bar settings 604 that appear on the virtual keyboard 110. The prioritize task buttons menu 606 allows user to prioritize the tasks that appear on the top, middle, bottom or left, middle and right corners of the virtual keyboard 110.

The customize menu items in a task bar selection 608 allows a user to customize the menu and submenu routines that are invoked within the virtual keyboard 110. The customize menu 608 includes the options to add, edit or remove menu items 610. The prioritize menu buttons 612 allows user to prioritize the menu options within the virtual keyboard 110.

The customized virtual keyboard can be stored as a separate virtual keyboard profile. If a computing device 102 is shared between two or more users, each user may configure and customize the virtual keyboard profile and activate his/her profile automatically on login. The virtual keyboard profile settings may be invoked as part of the computing device 102 start up. The menu and task bar customizations and default settings may be invoked through application programming interface by other applications. In one embodiment, the virtual keyboard including the customization and configuration options may be available as a software library for different computing devices and applications to install and activate.

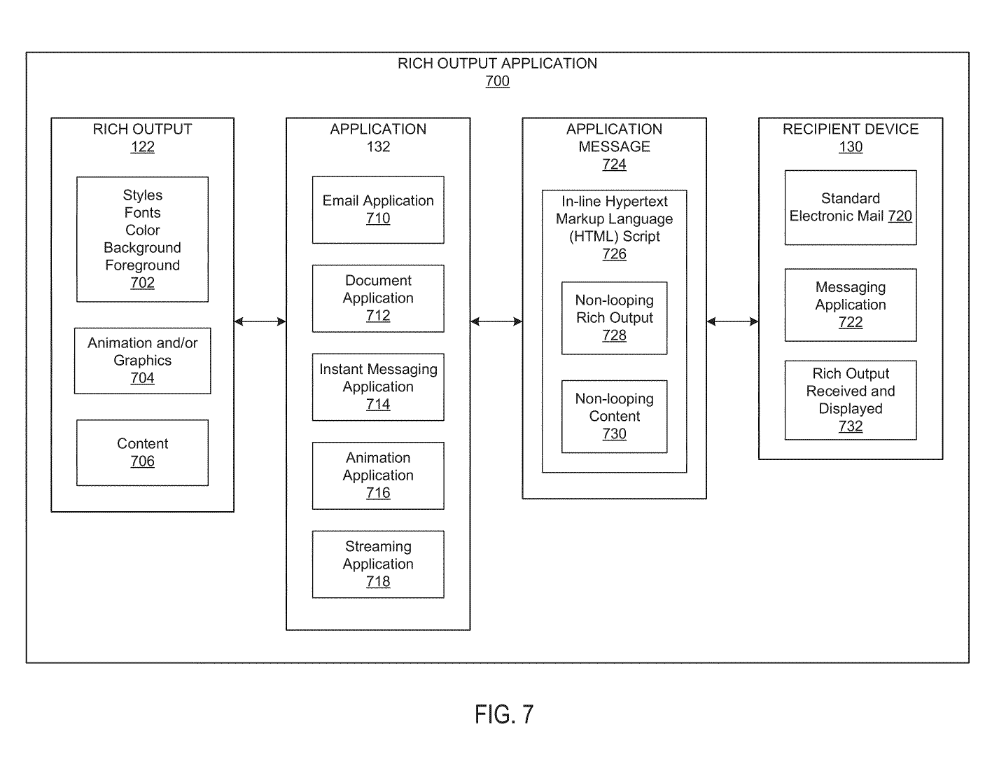

FIG. 7 is an exploded view of a rich output application 700 of the computing device 102 of FIG. 1 to a recipient device 130, according to one embodiment. Particularly, FIG. 7 includes rich output 122 that is built using different styles, fonts, color, background and foreground 702, animation and/or graphics 704 and content 706. In one embodiment, the content routine 706 further includes the options to add lossless compression and optimize the size of the content that is processed. The application 132 of FIG. 1 includes email application 710, document application 712, instant messaging application 714, animation application 716 and streaming application 718. An application message 724 that includes the rich output 122 may include an in-line hypertext markup language (HTML) script 726, a non-looping rich output 728, and a non-looping content 730, according to one embodiment. The content 730 includes one or more files, documents, text and multimedia content. The recipient device 130 may include a standard email application 720, a messaging application 722 and a rich output received and displayed function 732 that may be invoked and activated by different applications on the recipient device 130.

The lossless compression routine included with the content routine 706 may be a folder of a smaller output from a larger input of data without loss of information and/or data (e.g., image, video/audio file) eliminating redundancy of the rich output 122. The animation and/or graphics interchange format (GIF) file 704 may be an rich output 122 generated by the computing device 102 that contains within the single file a set of images having their RGB values defined in a palette table (e.g., that can hold up to 256 entries), and the data for the image may refer to the colors by their indices (e.g., 0-255) in the palette table that are presented in a specified order, according to one embodiment.

The content 706 may be a collection and/or a continuous stream of data and/or information (e.g., rich output 122) sent in compressed form over the Internet and displayed by the viewer in real time. The application 132 may be an elective and/or alternative computer or computer program which manages access to a centralized resource or service in a network (e.g., network 131) for storing the rich output 122 generated by the computing device 102. The email server 710 may be an application and/or a high-capacity computing device in a network (e.g., network 131) that runs software dedicated to send, deliver, and store electronic mail messages (e.g., rich output 122) to the recipient 320, according to one embodiment.

The document application 712 may be a dedicated server that connects a scanner device to the network (e.g., network 131), enabling users (e.g., user 108) to easily distribute digitized documents (e.g., rich output 122) over IP-networks. The instant messaging application 714 may be activated on a high-capacity computing device that runs software dedicated to a type of communications service that enables one to create a kind of private chat room with another individual in order to communicate in real time over the Internet. The animation application 716 may be a computer and/or computer program which manage access to a centralized resource or service in a network (e.g., network 131) for creating motion and/or shape change illusion by means of the rapid display of a sequence of static images that minimally differ from each other, according to one embodiment.

The streaming application 718 may be a computer and/or computer program that may deliver live or on-demand multimedia content to the client devices (e.g., recipient device 130). The standard electronic mail 720 may be part of a site that maintains one or more web pages for exchanging digital messages (e.g., rich output 122) from user 108 to one or more recipients (e.g., recipient 320). The messaging application 722 may be a program and/or a group of programs designed to send and/or receive rich output 122, according to one embodiment.

The application message 724 may be an exchange of digital communication from an author (e.g., user 108) to one or more recipients (e.g., recipient 320). The in-line hypertext markup language (HTML) script 726 may be a code in a scripting language technology used to create web pages that are displayed on web browsers for tagging text files to achieve font, color, graphic, and/or hyperlink effects on World Wide Web pages. The non-looping rich output 728 may be an rich output 122 generated after application of rich-typeface filter 120 (e.g., using rich-typeface filter function 126) programmed to execute in a non-looping fashion. The non-looping content 730 may be a collection of data and/or information in the form of moving visual images (e.g., rich output 122) that can be recorded, reproduced, broadcasted and/or displayed in a non-looping fashion, according to one embodiment.

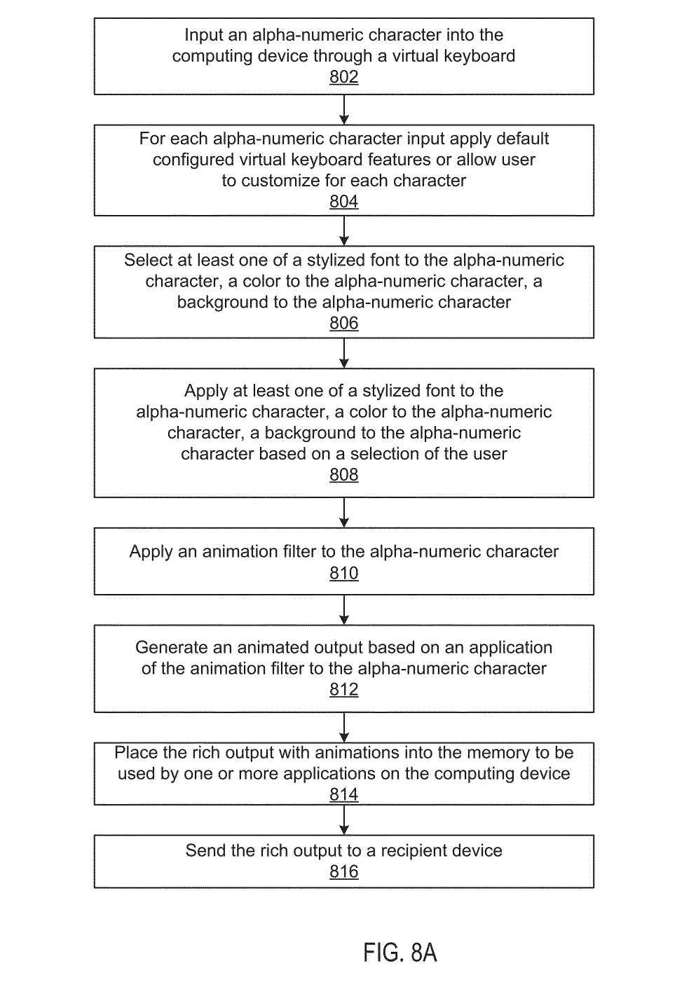

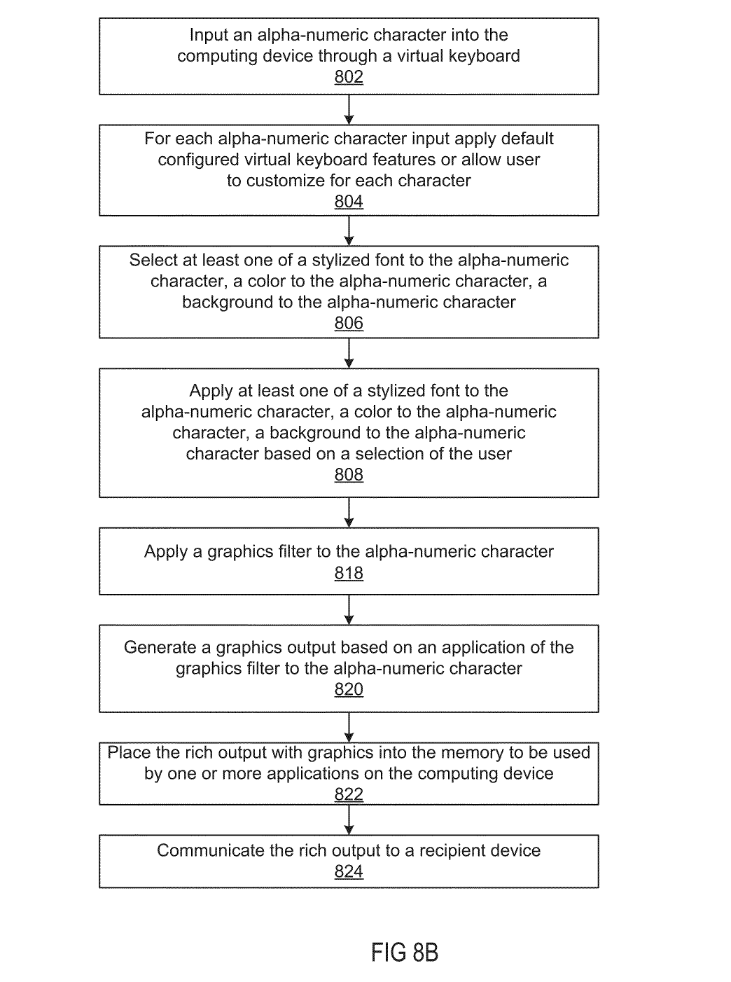

FIG. 8A is a path view illustrating a flow based on time in which operations of computing device of FIG. 1 are established, according to one embodiment. In operation 802, the user may enter an alpha-numeric character into the computing device through a virtual keyboard. In operation 804, for each alpha-numeric character input, the computing device may apply default configured virtual keyboard features or allow the user to customize rich output for each character. In operation 806, the user may select a stylized font to the alpha-numeric character, and/or a background to the alpha-numeric character. In operation 808, the computing device may apply a stylized font to the alpha-numeric character, a color to the alpha-numeric character, and/or a background to the alpha-numeric character based on a selection of the user 108. In operation 810, the computing device may apply an animation filter to the alpha-numeric character. In operation 812, the computing device may generate an animated output based on an application of the animation filter to the alpha-numeric character. In operation 814, the computing device may place the rich output into the memory to be used by one or more applications on the computing device. In the operation 816, the computing device may communicate the rich output to a recipient device, according to one embodiment.

FIG. 8B is a path view illustrating a flow based on time in which operations of computing device of FIG. 1 are established, according to one embodiment. In operation 802, the user may enter an alpha-numeric character into the computing device through a virtual keyboard. In operation 804, for each alpha-numeric character input, the computing device may apply default configured virtual keyboard features or allow the user to customize rich output for each character. In operation 806, the user may select a stylized font to the alpha-numeric character, and/or a background to the alpha-numeric character. In operation 808, the computing device may apply a stylized font to the alpha-numeric character, a color to the alpha-numeric character, and/or a background to the alpha-numeric character based on a selection of the user 108. In operation 810, the computing device may apply a graphics filter to the alpha-numeric character. In operation 812, the computing device may generate a graphics output based on an application of the graphics filter to the alpha-numeric character. In operation 814, the computing device may place the rich output into the memory to be used by one or more applications on the computing device. In the operation 816, the computing device may communicate the rich output to a recipient device, according to one embodiment.

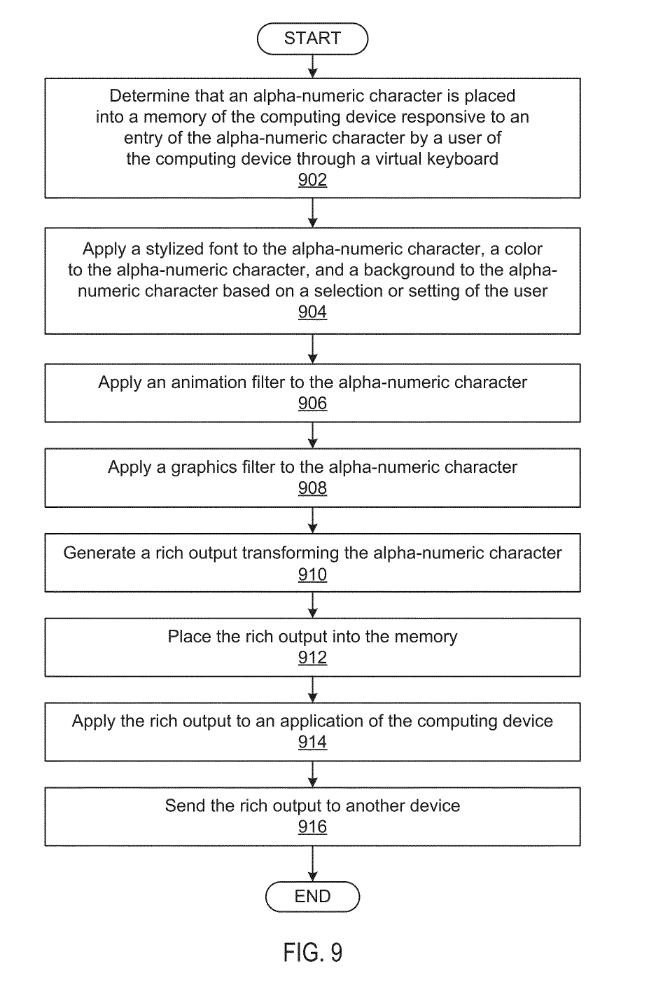

FIG. 9 is a process flow diagram of computing device of FIG. 1, according to one embodiment. In operation 902, a method of computing device may determine that an alpha-numeric character is placed into a memory of the computing device responsive to an entry of the alpha-numeric character by a user of the computing device through a virtual keyboard. In operation 904, a method of computing device may apply a stylized font to the alpha-numeric character, a color to the alpha-numeric character, and a background to the alpha-numeric character based on a selection of the user. In operation 906, the method may apply an animation filter to the alpha-numeric character. In operation 908, the method may apply a graphics filter to the alpha-numeric character. In operation 910, the method may generate an rich output based on an application of the rich-typeface filter to the alpha-numeric character. In operation 912, the method may place the rich output into the memory. In operation 914, the method may communicate the rich output to a recipient device through an application of the computing device and/or an operating system of the computing device, according to one embodiment. In operation 916, the computing device may send out the generated rich output to another device.

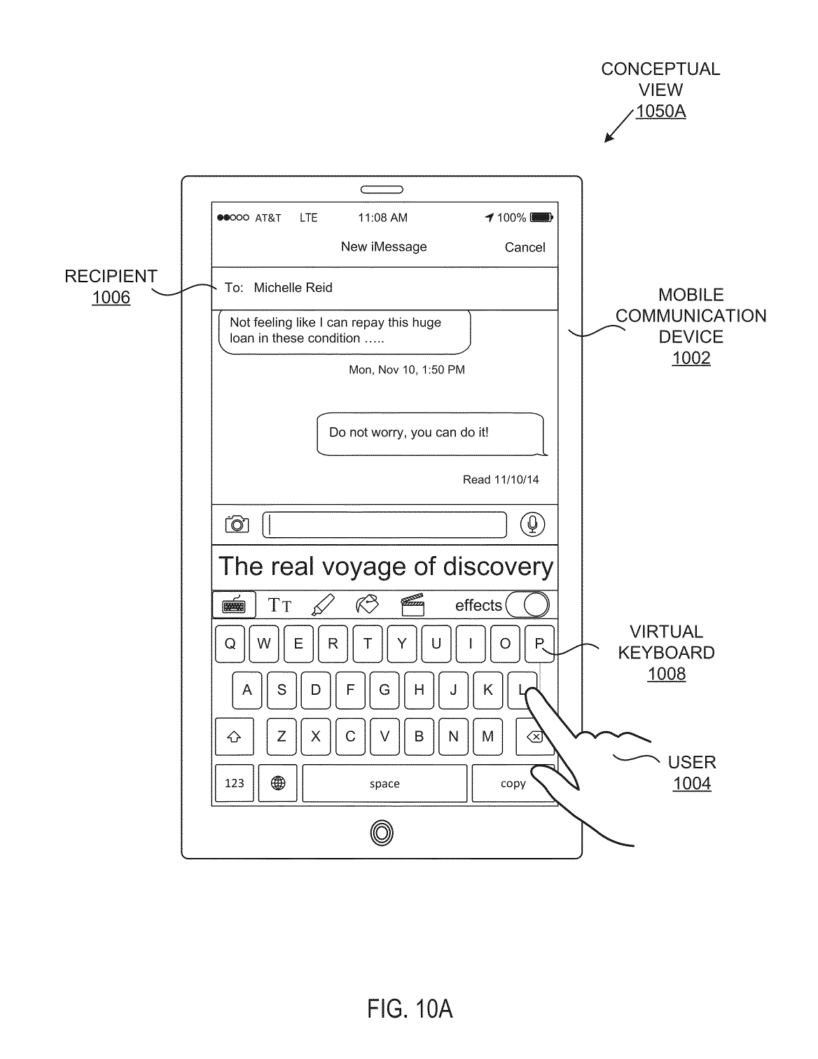

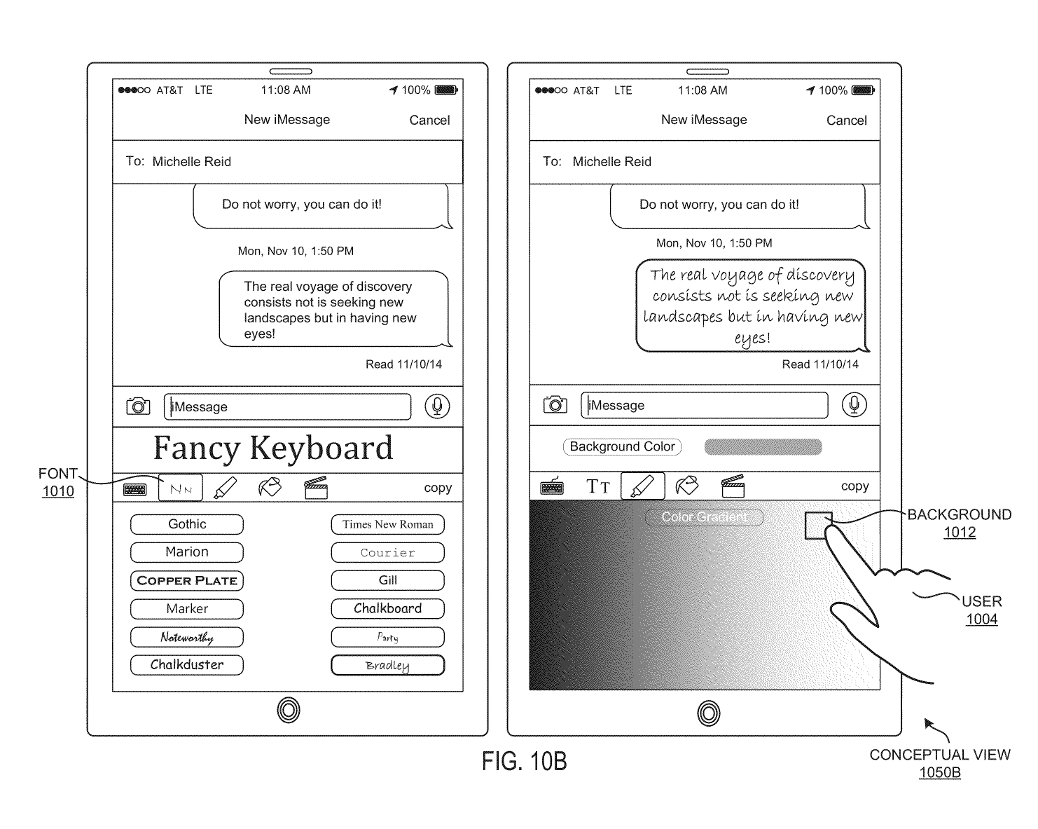

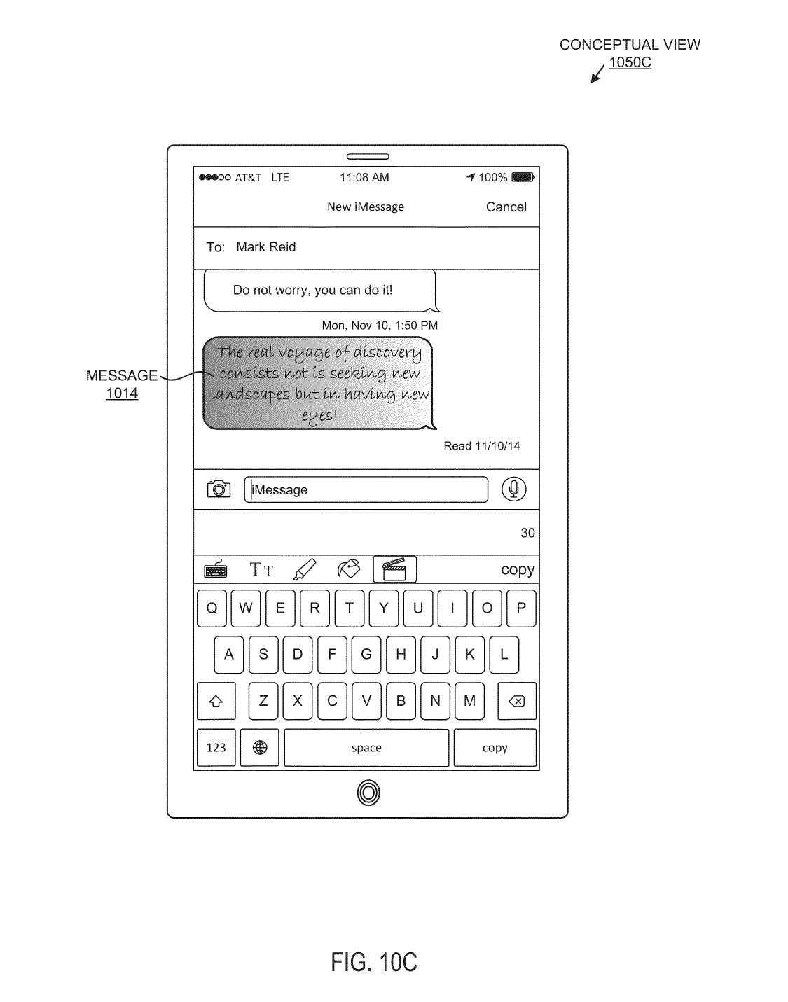

FIG. 10A is a conceptual view 1050A illustrating the user experience of creation of rich output using a virtual keyboard of the computing device of FIG. 1.

Mark Reid (e.g., user 1004) may want to send an inspirational quote to his depressed wife Michelle Reid (e.g., recipient 1006) who may have just lost heavily in a new venture that she may have worked really hard for the past two years. Michelle Reid (e.g., recipient 1006) may be feeling this morning she may not be able to repay the huge loan after she failed in meeting the contractual obligations in her new venture. Mark Reid (e.g., user 1004) may have come across a beautiful message that he felt will help inspire Michelle Reid (e.g., recipient 1006) to take a new step ahead to start all over again. Mark Reid may want this message (e.g., message 1014) to send in a creative manner (e.g., using the various embodiments of FIGS. 1-9) which may express his affection for Michelle Reid (e.g., recipient 1006). For this reason, Mark Reid (e.g., user 1004) may have used his mobile device (e.g., computing device 1002) having the new features of the invention described herein (e.g., using the various embodiments of FIGS. 1-9) for enhancing the message that he wish to send Michelle.

FIG. 10A illustrates the conceptual view 1050A showing Mark Reid (e.g., user 1004) messaging his wife Michelle Reid (e.g., recipient 1006). FIG. 10B illustrates Mark Reid using the fancy keyboard (e.g., virtual keyboard 1008) as described in the various embodiments of FIGS. 1-9 for choosing the new stylized font (e.g., font 1010) for his message (e.g., message 1014) and a color background (e.g., background 1012) for its display (e.g., using the various embodiments of FIGS. 1-9). Mark Reid (e.g., user 1004) may have sent this message with this new configuration that Michelle Reid (e.g., recipient 1006) may access multiple times. The use of various embodiments as described in FIGS. 1-9 may enable the message (e.g., message 1014) to be displayed in a creative way as illustrated in FIG. 10C that Mark Reid may have been looking for. Michelle Reid (e.g., recipient 1006) may have felt really touched by the message sent by Mark Reid (e.g., user 1004) in a new colorful message expressing his emotions for her. Michelle Reid may now feel inspired for taking new challenges all over again making her happy.

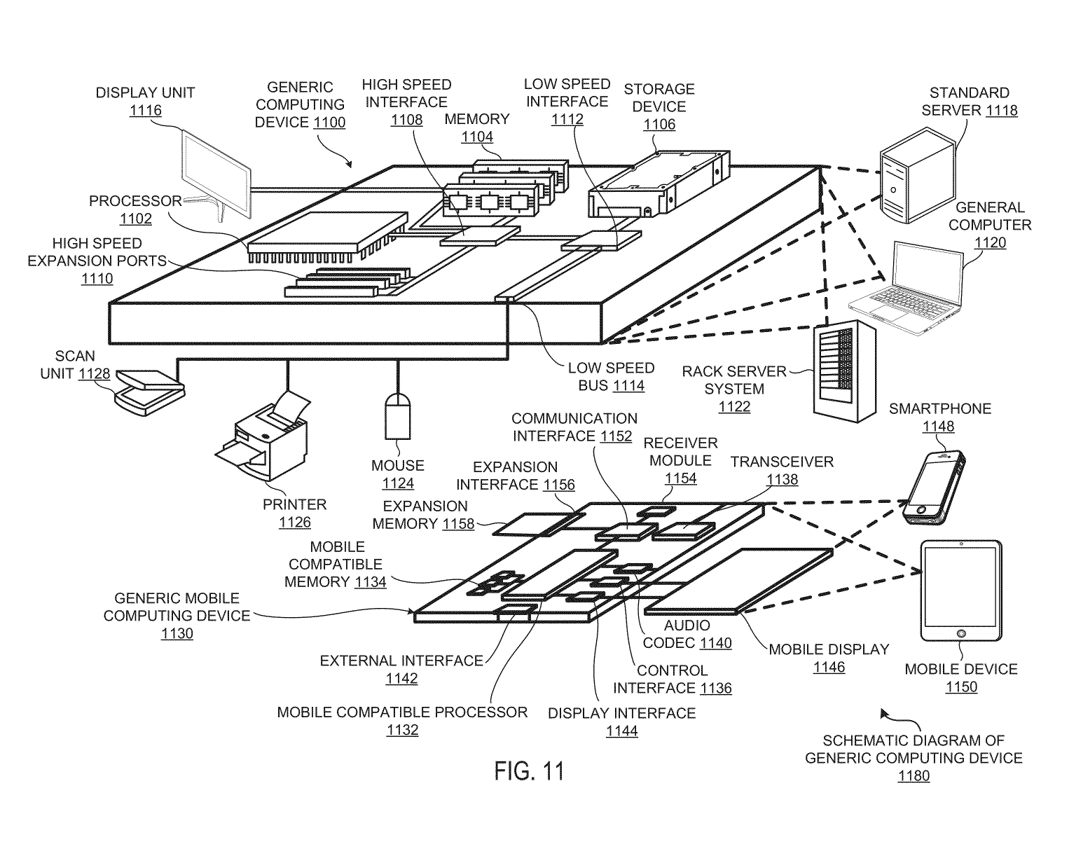

FIG. 11 is a schematic diagram of computing device 1100 that can be used to implement the methods and systems disclosed herein, according to one or more embodiments. FIG. 11 is a schematic of a computing device 1100 and a mobile device 1150 that can be used to perform and/or implement any of the embodiments disclosed herein. In one or more embodiments, computing device 102 and/or recipient device 130 of FIG. 1 may be the computing device 1100.

The computing device 1100 may represent various forms of digital computers, such as laptops, desktops, workstations, personal digital assistants, servers, blade servers, mainframes, and/or other appropriate computers. The mobile device 1150 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

The computing device 1100 may include a processor 1102, a memory 1104, a storage device 1106, a high speed interface 1108 coupled to the memory 1104 and a plurality of high speed expansion ports 1110, and a low speed interface 1112 coupled to a low speed bus 1114 and a storage device 1106. In one embodiment, each of the components heretofore may be inter-coupled using various buses, and may be mounted on a common motherboard and/or in other manners as appropriate. The processor 1102 may process instructions for execution in the computing device 1100, including instructions stored in the memory 1104 and/or on the storage device 1106 to display a graphical information for a GUI on an external input/output device, such as a display unit 1116 coupled to the high speed interface 1108.

In other embodiments, multiple processors and/or multiple buses may be used, as appropriate, along with multiple memories and/or types of memory. Also, a plurality of computing device 1100 may be coupled with, with each device providing portions of the necessary operations (e.g., as a server bank, a group of blade servers, and/or a multi-processor system).

The memory 1104 may be coupled to the computing device 1100. In one embodiment, the memory 1104 may be a volatile memory. In another embodiment, the memory 1104 may be a non-volatile memory. The memory 1104 may also be another form of computer-readable medium, such as a magnetic and/or an optical disk. The storage device 1106 may be capable of providing mass storage for the computing device 1100. In one embodiment, the storage device 1106 may be includes a floppy disk device, a hard disk device, an optical disk device, a tape device, a flash memory and/or other similar solid state memory device. In another embodiment, the storage device 1106 may be an array of the devices in a computer-readable medium previously mentioned heretofore, computer-readable medium, such as, and/or an array of devices, including devices in a storage area network and/or other configurations.

A computer program may be inclusive of instructions that, when executed, perform one or more methods, such as those described above. The instructions may be stored in the memory 1104, the storage device 1106, a memory coupled to the processor 1102, and/or a propagated signal.

The high speed interface 1108 may manage bandwidth-intensive operations for the computing device 1100, while the low speed interface 1112 may manage lower bandwidth-intensive operations. Such allocation of functions is exemplary only. In one embodiment, the high speed interface 1108 may be coupled to the memory 1104, the display unit 1116 (e.g., through a graphics processor and/or an accelerator), and to the plurality of high speed expansion ports 1110, which may accept various expansion cards.

In the embodiment, the low speed interface 1112 may be coupled to the storage device 1106 and the low speed bus 1114. The low speed bus 1114 may be comprised of a wired and/or wireless communication port (e.g., a Universal Serial Bus (“USB”), a Bluetooth® port, an Ethernet port, and/or a wireless Ethernet port). The low speed bus 1114 may also be coupled to the scan unit 1128, a printer 1126, a keyboard, a mouse 1124, and a networking device (e.g., a switch and/or a router) through a network adapter.

The computing device 1100 may be implemented in a number of different forms, as shown in the figure. In one embodiment, the computing device 1100 may be implemented as a standard server 1118 and/or a group of such servers. In another embodiment, the computing device 1100 may be implemented as part of a rack server system 1122. In yet another embodiment, the computing device 1100 may be implemented as a general computer 1120 such as a laptop or desktop computer. Alternatively, a component from the computing device 1100 may be combined with another component in a mobile device 1150. In one or more embodiments, an entire system may be made up of a plurality of computing device 1100 and/or a plurality of computing device 1100 coupled to a plurality of mobile device 1150.

In one embodiment, the mobile device 1150 may include a mobile compatible processor 1132, a mobile compatible memory 1134, and an input/output device such as a mobile display 1146, a communication interface 1152, and a transceiver 1138, among other components. The mobile device 1150 may also be provided with a storage device, such as a micro-drive or other device, to provide additional storage. In one embodiment, the components indicated heretofore are inter-coupled using various buses, and several of the components may be mounted on a common motherboard.

The mobile compatible processor 1132 may execute instructions in the mobile device 1150, including instructions stored in the mobile compatible memory 1134. The mobile compatible processor 1132 may be implemented as a chipset of chips that include separate and multiple analog and digital processors. The mobile compatible processor 1132 may provide, for example, for coordination of the other components of the mobile device 1150, such as control of user interfaces, applications run by the mobile device 1150, and wireless communication by the mobile device 1150.

The mobile compatible processor 1132 may communicate with a user through the control interface 1136 and the display interface 1144 coupled to a mobile display 1146. In one embodiment, the mobile display 1146 may be a Thin-Film-Transistor Liquid Crystal Display (“TFT LCD”), an Organic Light Emitting Diode (“OLED”) display, and another appropriate display technology. The display interface 1144 may include appropriate circuitry for driving the mobile display 1146 to present graphical and other information to a user. The control interface 1136 may receive commands from a user and convert them for submission to the mobile compatible processor 1132.

In addition, an external interface 1142 may be provided in communication with the mobile compatible processor 1132, so as to enable near area communication of the mobile device 1150 with other devices. External interface 1142 may provide, for example, for wired communication in some embodiments, or for wireless communication in other embodiments, and multiple interfaces may also be used.

The mobile compatible memory 1134 may be coupled to the mobile device 1150. The mobile compatible memory 1134 may be implemented as a volatile memory and a non-volatile memory. The expansion memory 1158 may also be coupled to the mobile device 1150 through the expansion interface 1156, which may comprise, for example, a Single In Line Memory Module (“SIMM”) card interface. The expansion memory 1158 may provide extra storage space for the mobile device 1150, or may also store an application or other information for the mobile device 1150.

Specifically, the expansion memory 1158 may comprise instructions to carry out the processes described above. The expansion memory 1158 may also comprise secure information. For example, the expansion memory 1158 may be provided as a security module for the mobile device 1150, and may be programmed with instructions that permit secure use of the mobile device 1150. In addition, a secure application may be provided on the SIMM card, along with additional information, such as placing identifying information on the SIMM card in a non-hackable manner.

The mobile compatible memory may include a volatile memory (e.g., a flash memory) and a non-volatile memory (e.g., a non-volatile random-access memory (“NVRAM”)). In one embodiment, a computer program comprises a set of instructions that, when executed, perform one or more methods. The set of instructions may be stored on the mobile compatible memory 1134, the expansion memory 1158, a memory coupled to the mobile compatible processor 1132, and a propagated signal that may be received, for example, over the transceiver 1138 and/or the external interface 1142.

The mobile device 1150 may communicate wirelessly through the communication interface 1152, which may be comprised of a digital signal processing circuitry. The communication interface 1152 may provide for communications using various modes and/or protocols, such as, a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol.

Such communication may occur, for example, through the transceiver 1138 (e.g., radio-frequency transceiver). In addition, short-range communication may occur, such as using a Bluetooth®, Wi-Fi, and/or other such transceiver. In addition, a GPS (“Global Positioning System”) receiver module may provide additional navigation-related and location-related wireless data to the mobile device 1150, which may be used as appropriate by a software application running on the mobile device 1150.

The mobile device 1150 may also communicate audibly using an audio codec 1140, which may receive spoken information from a user and convert it to usable digital information. The audio codec 1140 may likewise generate audible sound for a user, such as through a speaker (e.g., in a handset of the mobile device 1150). Such a sound may comprise a sound from a voice telephone call, a recorded sound (e.g., a voice message, a music files, etc.) and may also include a sound generated by an application operating on the mobile device 1150.

The mobile device 1150 may be implemented in a number of different forms, as shown in the figure. In one embodiment, the mobile device 1150 may be implemented as a smartphone 1148. In another embodiment, the mobile device 1150 may be implemented as a personal digital assistant (“PDA”). In yet another embodiment, the mobile device, 1150 may be implemented as a tablet device.

Various embodiments of the systems and techniques described here can be realized in a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including one programmable processor, which may be special or general purpose, coupled to receive data and instructions from, and to transmit data and instructions to, a storage system, one input device, and one output device.

Various embodiments of the systems and techniques described here can be realized in a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system includes programmable processor, which may be special or general purpose, coupled to receive data and instructions from, and to transmit data and instructions to, a storage system, input device, and output device.

These computer programs (also known as programs, software, software applications, and/or code) comprise machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g., magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computing device having a display device (e.g., a cathode ray tube (“CRT”) and/or liquid crystal (“LCD”) monitor) for displaying information to the user and a keyboard and a mouse 1124 by which the user can provide input to the computer. Other kinds of devices can be used to provide for interaction with a user as well; for example, feedback provided to the user can be any form of sensory feedback (e.g., visual feedback, auditory feedback, and/or tactile feed [symbol] back) and input from the user can be received in any form, including acoustic, speech, and/or tactile input.

The systems and techniques described here may be implemented in a computing system that includes a back end component (e.g., as a data server), a middleware component (e.g., an application server), a front end component (e.g., a client computer having a graphical user interface, and/or a Web browser through which a user can interact with an embodiment of the systems and techniques described here), and a combination thereof. The components of the system may also be coupled through a communication network.

The communication network may include a local area network (“LAN”) and a wide area network (“WAN”) (e.g., the Internet). The computing system can include a client and a server. In one embodiment, the client and the server are remote from each other and interact through the communication network.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of a computing device comprising:
determining that an alpha-numeric character is placed into a memory of the computing device responsive to an entry of the alpha-numeric character by a user of the computing device through a virtual keyboard;
selecting at least one of a stylized font to the alpha-numeric character, a color to the alpha-numeric character, a foreground, a background, a graphics and an animation to the alpha-numeric character;
applying at least one of the selected stylized font, the color, the foreground, the background, the graphics and the animation using a rich-typeface filter to the alpha-numeric character;
generating a rich output based on an application of the rich-typeface filter to the alpha-numeric character,
placing the rich output into the memory to be used by one or more applications of the computing device.

2. The method of claim 1 wherein the available stylized fonts, colors, foregrounds, backgrounds, graphics and animations for selection are customized by the user.

3. The method of claim 1, further comprising:
communicating the rich output to a recipient device through at least one of an application of the computing device and an operating system of the computing device.

4. The method of claim 3:
wherein the recipient device uses at least one of a messaging application, and a standard electronic mail website to access the rich output.

5. The method of claim 1, further comprising:
determining a context in which the virtual keyboard is activated, wherein the context is based on a function being performed through the computing device by the user through an application using a content accessed by the user of the computing device;
determining whether the content is a video file, an audio-visual file, a graphics-interchange-format (GIF) file based on the context;
selecting based on the context which of the following operations are performed when the rich output is created, wherein the operations include at least one of:
to copy the rich output to a clipboard of the operating system,
to store in a photo library,
to communicate the rich output through an application of the computing device,
to communicate to a third-party website server through an application programming interface offered by the third-party website server through an application of a mobile device.

6. The method of claim 5 further comprising at least one of:
wherein the rich output includes content that is at least one of a lossless compression output, a Graphics Interchange Format (GIF) output and a streaming video output;
wherein the portions or whole of the generated rich output are included in an application message sent to a recipient device;
wherein the application message comprises at least one of: an in-line Hypertext Markup Language (HTML) script, non-looping rich output and non-looping content.

7. The method of claim 1 wherein the selecting is based on at least one of:
selection of a user;
default configuration setting;
selected virtual keyboard profile.

8. The method of claim 7 further comprising:
configuring or customizing the virtual keyboard keys;
saving one or more virtual keyboard profiles;
activating one or more virtual keyboard profiles;
using one or more virtual keyboard profiles.

9. The method of claim 8 further comprising at least one of:
selecting a default setting of one or more font, styles, foreground, background, graphics and animation settings;
customizing one or more buttons on the menu or task bar of the virtual keyboard by adding, editing or removing buttons;
prioritizing the buttons on the menu or task bar of the virtual keyboard.

10. The method of claim 1 further comprising:
using a set of alpha-numeric characters responsive to an entry by the user;
wherein the set of alpha-numeric characters is selected based on at least one of:
selection from an existing file, clipboard and keyboard.

11. A system of a computing device comprising:
to determine that an alpha-numeric character is placed into a memory of the computing device responsive to an entry of the alpha-numeric character by a user of the computing device through a virtual keyboard;
to select at least one of a stylized font to the alpha-numeric character, a color to the alpha-numeric character, a foreground, a background, a graphics and an animation to the alpha-numeric character;
to apply at least one of the selected stylized font, the color, the foreground, the background, the graphics and the animation using a rich-typeface filter to the alpha-numeric character;
to generate a rich output based on an application of the rich-typeface filter to the alpha-numeric character,
to place the rich output into the memory to be used by one or more applications of the computing device.

12. The system of claim 11, wherein the available stylized fonts, colors, foregrounds, backgrounds, graphics and animations for selection are customized by the user.

13. The system of claim 11, further comprising:
to communicate the rich output to a recipient device through at least one of an application of the computing device and an operating system of the computing device.

14. The system of claim 13:
wherein the recipient device uses at least one of a messaging application, and a standard electronic mail website to access the rich output.

15. The system of claim 11, further comprising:
to determine a context in which the virtual keyboard is activated, wherein the context is based on a function being performed through the computing device by the user through an application using a content accessed by the user of the computing device;
to determine whether the content is a video file, an audio-visual file, a graphics-interchange-format (GIF) file based on the context;
to select based on the context which of the following operations are performed when the rich output is created, wherein the operations include at least one of:
to copy the rich output to a clipboard of the operating system,
to store in a photo library,
to communicate the rich output through an application of the computing device,
to communicate to a third-party website server through an application programming interface offered by the third-party website server through an application of a mobile device.

16. The system of claim 15 further comprising at least one of:
wherein the rich output includes content that is at least one of a lossless compression output, a Graphics Interchange Format (GIF) output and a streaming video output;
wherein the portions or whole of the generated rich output are included in an application message sent to a recipient device;
wherein the application message comprises at least one of: an in-line Hypertext Markup Language (HTML) script, non-looping rich output and non-looping content.

17. The system of claim 11 wherein the selecting is based on at least one of:
selection of a user;
default configuration setting;
selected virtual keyboard profile.

18. The system of claim 17 further comprising:
to configure or customize the virtual keyboard keys;
to save one or more virtual keyboard profiles;
to activate one or more virtual keyboard profiles;
to use one or more virtual keyboard profiles.

19. The system of claim 18 further comprising at least one of:
to select a default setting of one or more font, styles, foreground, background, graphics and animation settings;
to customize one or more buttons on the menu or task bar of the virtual keyboard by adding, editing or removing buttons;
to prioritize the buttons on the menu or task bar of the virtual keyboard.

20. The system of claim 11 further comprising:
to use a set of alpha-numeric characters responsive to an entry by the user;
wherein the set of alpha-numeric characters is selected based on at least one of:
selection from an existing file, clipboard and keyboard.
